(19) United States
(12) Patent Application Publication
(10) Pub. No.: US 2007/0070097 A1
(43) Pub. Date: Mar. 29, 2007

(54) Liquid jet head and a liquid ejecting instrument including such a liquid jet head

(76) Inventors: Xavier Bich, Neuilly Sur Seine (FR); Alain Rosenzweig, Saint Maur Des Fosses (FR); Kurt Rath, Asnieres Sur Seine (FR); Marc Adrian Borrett, Berkshire (GB); Colin Philip Brooks, Berkshire (GB); Andrew Thomas Hills, Middlesex (GB)

Correspondence Address: JONES DAY, 222 EAST 41ST ST, NEW YORK, NY, 10017, US

(21) Appl. No.: 10/576,338

(22) PCT Filed: Oct. 17, 2003
(86) PCT No.: PCT/IB03/05274

§ 371 Date: Apr. 17, 2006

(51) Int. Cl. B41J 25/308

(52) U.S. Cl. 347/8; 347/19

(57) ABSTRACT

An embodiment of the present invention relates to liquid jet heads, and to liquid ejecting instruments including such liquid jet heads. The liquid ejecting instruments may be formed by ink jet printers or self-contained writing devices and in particular, to those devices that employ a non-contact method of transferring ink to a writing medium. An embodiment of the present invention also concerns those liquid or ink ejecting instruments that can be held in a user's hand.

### INTRODUCTION

This is a national stage Application of International Patent Application No. PCT/IB03/05274, filed Oct. 17, 2003.

The present invention relates to liquid jet heads, and, in particular, liquid ejecting instruments that includes such liquid jet heads.

### BACKGROUND OF THE INVENTION

In the ink jet printers known in the art, the recording medium, namely an ink receiving member, such as paper or other writing surface, is fed into the printer and an image is formed while conveying the medium in a direction perpendicular to the direction in which the ink jet head is moved. Consequently, ink may be inadvertently ejected from the ink jet system, and more particularly, from the at least one nozzle of the ink jet system positioned on the substrate. For example, ink droplets can be accidentally ejected before the nozzle of the ink jet system has been correctly opposed to the medium.

On the other hand, when the liquid ejecting instrument is formed by an ink jet pen comprising a tubular instrument intended to be held in the hand of a user, the tubular element includes a feeler having a first end serving to come into contact with the medium during the writing, and a second end connected to a movement detector mechanism for detecting movement of the feeler in contact with the medium. That movement detector mechanism is connected to the control unit to enable the liquid jet head to be activated. Therefore, although the liquid jet head does not need to be in contact with the medium, it is nevertheless essential for the feeler of the pen to be in contact with the medium in order to be able to start ejecting the liquid. Therefore, it can be inconvenient for the user to put the feeler into contact with the medium in particular when the medium is rough to some extent.

In addition, since the end of the feeler in contact with the medium is generally close to the point of impact of the liquid jet of the medium, there are risks that the end of the feeler may come into contact with the liquid before it dries, thereby smearing it over the medium while the ink jet pen is in normal use.

The present invention includes embodiments that mitigate the above-mentioned technical problems by providing a liquid jet head designed to be mounted on a liquid ejecting instrument, for instance, such an ink jet printer, in which the liquid jet head is so reliable that it makes it possible to prevent liquid droplets from being accidentally ejected, when said liquid jet head has not been correctly opposed to the medium, or when the liquid ejecting instrument is formed by an ink jet pen to provide a liquid jet head that is reliable and procures good writing comfort for the user.

### SUMMARY OF THE INVENTION

To this end, embodiment of the present invention provide a liquid jet head designed to be mounted on a liquid ejecting instrument, said liquid jet head comprising a substrate which is designed to be mounted on the liquid ejecting instrument, and a liquid jet system positioned on the substrate, the liquid jet system being adapted for ejecting liquid onto a medium from a distance, the liquid jet system being further designed to be coupled to a control unit serving to activate the liquid jet system for ejecting liquid onto said medium measurement means for acting, without physical contact, with the medium to measure the distance between the liquid jet head and the medium, the measurement means being designed to be coupled to the control unit, and being positioned on the substrate.

The other embodiments of the present invention may additionally include:
the control unit positioned on the substrate;
the measurement means including an optical system serving to measure the distance between the liquid jet head and the medium;
the measurement means including an ultrasonic acoustic probe serving to measure the distance between the liquid jet head and the medium;
the substrate comprising a supply channel which extends between an inlet port designed to be connected to a liquid tank housed within the liquid ejecting instrument, and an outlet port connected to the liquid jet system;
the substrate being made of material from a group consisting essentially of glass, silicon, ceramic and polymer materials;
the liquid jet system comprising a thermal liquid jet system adapted for ejecting liquid droplets from at least one orifice by an explosive formation of a vapor bubble within the liquid contained in the liquid jet system;

The substrate is formed by a plate having a first side designed to face the medium and a second side opposite to the first side, and wherein the thermal liquid jet system comprises:
at least one resistive heater element positioned on a first side of the substrate, and
a block mounted on a first side of the substrate, the block having at least one liquid channel having an inlet chamber and an outlet orifice facing the at least one resistive heater element for ejecting ink droplets onto the medium;
movement detector means positioned on the substrate, movement, the movement detector means being adapted to detect movement of the liquid jet head and to be coupled to the control unit.

Furthermore, another embodiment of the present invention also includes a liquid ejecting instrument comprising a substantially tubular element extending between a first end and a second end and designed to be hand-held by a user, the tubular element comprising:
a liquid tank;
an electrical power source, and
a liquid jet head as defined above, the liquid jet head being mounted at the first end of the tubular element and connected to the electrical power source.

### BRIEF DESCRIPTION OF THE DRAWINGS

FIG. 1 is a diagrammatic cross-sectional view of a liquid ejecting instrument provided with a liquid jet head according to a first embodiment of the invention;

FIG. 2 is an extended cross-sectional view of a portion of the liquid ejecting instrument of FIG. 1, showing in detail the liquid jet head according to the first embodiment;

FIG. 3 is a perspective view showing one side of the liquid jet head according to the first embodiment;

FIG. 4 is an exploded perspective view showing another side of the liquid jet head of FIG. 3;

FIG. 5 is a block diagram of the various component elements which may be integrated into the liquid jet head;

FIG. 6 is a diagrammatic cross-sectional view of a liquid ejecting instrument provided with a liquid jet head according to another embodiment of the invention; and

FIG. 7 is an extended cross-sectional view of a portion of the liquid ejecting instrument of FIG. 6, showing in detail the liquid jet head.

### DETAILED DESCRIPTION OF INVENTION

In the various Figures, the same references designate elements that are identical or similar.

FIG. 1 shows a liquid ejecting instrument 1 which has a substantially tubular element 2 that extends between a first end 2a and a second end 2b for forming a pen. The tubular element 2 has an inside wall 21 defining a hollow internal space, and an outside wall 22 designated to be held in the hand of a user.

The hollow internal space defined by the inside wall 21 of the tubular element 2 contains an electrical power source 3, a liquid tank 4 and a liquid jet head 5 at the opened first end 2a of the tubular element 2, the liquid jet head 5 being directly associated with the liquid tank 4 by a fluid communication.

The electrical power source 3 housed in the hollow internal space of the tubular element 2 may be formed, for example, by a battery or a plurality of batteries which may be rechargeable, making it possible, by means of a switch 6 located at the second end 2b of the tubular element 2, to switch on the various electrical elements of the liquid jet head 5. The electrical power source 3 and the liquid jet head 5 are connected by means of two power wirings 31.

The switch 6 may be replaced by any switch-on means that can be actuated by the user of the instrument, and in particular by means for detecting that the tubular element 2 is being held in the hand of the user, and such as, for example, a capacitive sensor disposed at the outside wall 2 of the tubular element 2 and serving to detect pressure when the user takes hold of the instrument.

By way of example, the end 2b of the tubular element may be in the form of a cap that is removably mounted in the central portion of the tubular element 2 to enable the electrical power source 3 to be replaced by a new electrical power source.

The liquid tank 4 may also be mounted removably in the hollow internal space of the tubular element 2 so as to be replaced by another tank once the liquid has run out. Depending on what the instrument is used for, the liquid contained in the tank may be formed by an ink, or by an ink-erasing or ink-masking liquid when the instrument is used as a corrector, or indeed by an adhesive when said instrument is used as an adhesive applicator or spray, the liquid having sufficient properties to be ejected from the liquid jet head 5.

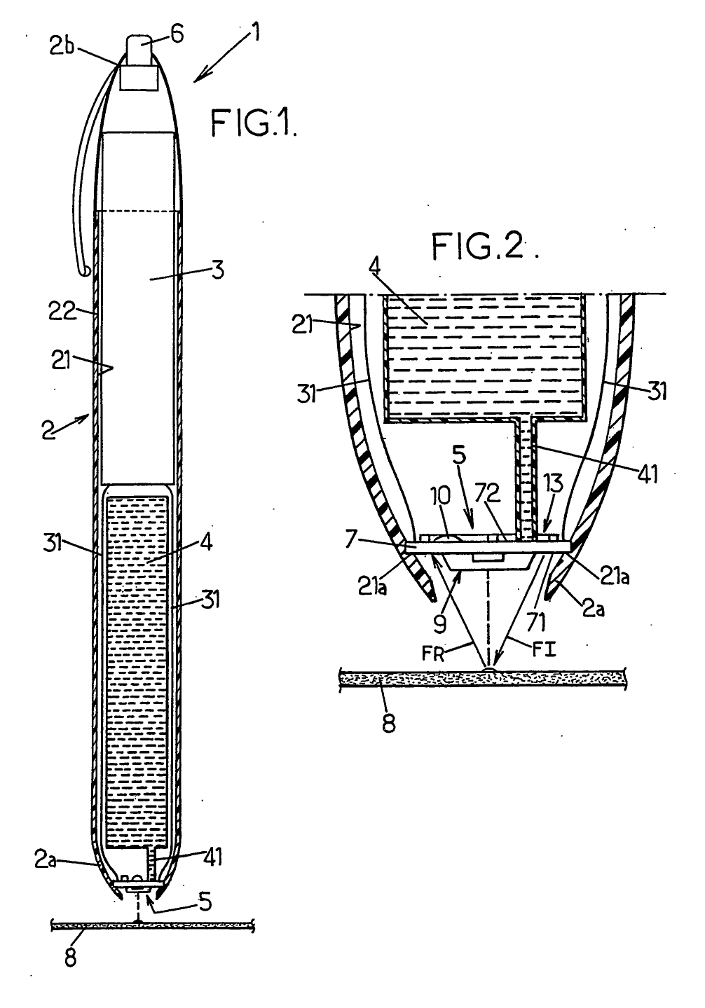

As illustrated in FIGS. 1 and 2, in the example considered herein, the liquid jet head 5 is disposed at the open end 2a of the tubular element 2. The open end 2a may be constituted by an end-piece fitted directly into the inside wall 22 of the central portion of the tubular element 2.

The liquid jet head 5 comprises a substrate 7 that may be mounted on the inside wall 21 of the tubular element 2.

The contour of the substrate 7 and the inside wall 21 of the tubular element have complementary forms which may be circular, rectangular, square or triangular. The contour of the substrate 7, as illustrated in FIG. 2, is directly fixed on a shoulder 21a formed in the inside wall 21 of the tubular element 2. The contour of the substrate 7 may be fixed on the shoulder 21a of the inside wall 21 by adhesive, welding, clipping means or other fixing means. The substrate 7 may be made of glass or silicon or ceramics or other electrical insulators.

As illustrated in FIGS. 2 to 5, the substrate 7 according to the first embodiment is formed by a circular horizontal plate having a first side 71 designed to face a medium 8 or writing surface and a second side 72 opposite to the first side 71, the second side 72 facing the liquid tank 4.

The liquid jet head 5 further comprises a liquid jet system 9 positioned on the first side 71 of the substrate 7, the liquid jet system 9 being adapted for ejecting liquid onto the medium from a distance and without physical contact with the medium 8.

Furthermore, the substrate 7 may also comprise, on its second side 72, a control unit 10 serving to activate the liquid jet system 9 for ejecting liquid onto the medium 8. The control unit 10 may include an electrical signal (or electrical pulse) generator to make it possible for the liquid jet system 9 to eject liquid droplets onto the medium 8 from a distance.

The liquid jet system 9 may be formed by a thermal liquid jet system adapted for ejecting liquid droplets from at least one orifice by an explosive formation of a vapor bubble within the liquid contained in the liquid jet system.

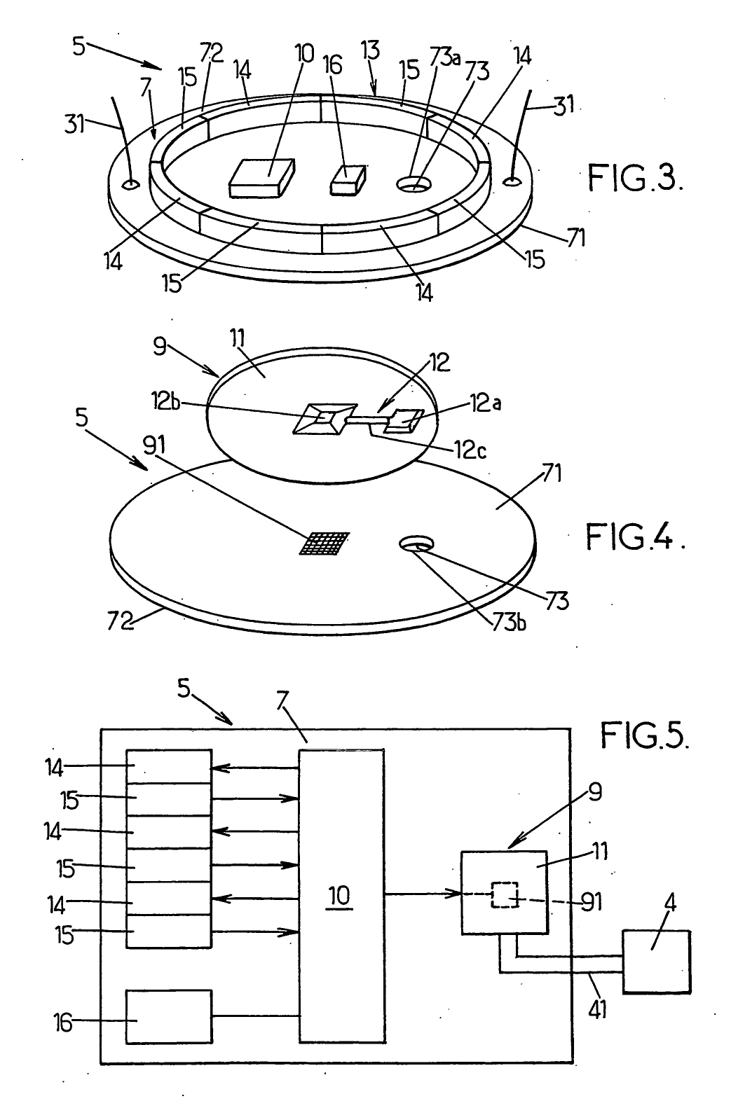

As illustrated in FIGS. 3 and 4, the thermal liquid jet system 9 may comprise at least one resistive heater element 91 fixed on a first side 71 of the substrate 7 and which is coupled to the electrical signal generator of the control unit 10, and a block 11 mounted on the same first side 71 and which covers the resistive heater element 91. More particularly, the block 11 has at least one liquid channel 12 extending between an inlet chamber 12a that includes a bottom and an outlet orifice 12b which is designed to face the resistive heater element 91 fixed on the substrate 7. The outlet orifice 12b is shaped and adapted to permit the ejection of fine droplets when electrical signals are applied from the generator to the resistive heater element 91 in order to instantly increase the temperature of the resistive heater element 91, thereby forming a bubble of vapor in the liquid, which bubble expels a fine droplet of liquid onto the medium.

The liquid channel 12 also includes a central portion 12c connecting the inlet chamber 12a to the outlet orifice 12b, thereby providing a capillary channel 12 for liquid to flow to the resistive heater element 91.

The substrate 7 also includes a supply channel 73 extending between an inlet port 73a connected to a supplying line 41 of the liquid tank 4 (FIG. 2) and an outlet port 73b opening into the inlet chamber 12a of the block 11 when said block is positioned and fixed on the first side 71 of the substrate 7.

In this embodiment, the liquid capillary channel 12 is located at the interface of the substrate 7 and the block 11 and is sealed by the fixation of the block on the first side 71 of the substrate 7. Typical materials used for substrate 7 are electrical insulators such as glass, ceramics, a coated material or silicon, while the materials used for block 11 are generally chosen for their ease to manufacture in regard to liquid capillary channel 12. For example, block 11 may be made of molded glass, etched silicon or etched glass. The block 11 may be also formed by a metal plate. In its construction, substrate 7 and block 11 can be sealed together in a variety of ways, for example, by epoxy, anodic bonding or with sealing glass. However, the liquid jet system 9 may also be formed by piezoelectric effect jet system including a piezoelectric element instead of the resistive heater element 91, the piezoelectric element being adapted to be deformed when it is subjected to electrical signals coming from the generator of the control unit 10.

The liquid-jet system 9 may also operate using MEMS (Micro Electro Mechanical System) technology or a combination of piezoelectric, thermal and/or MEMS technology.

The liquid jet head 5 also comprises measurement means 13 directly positioned on the substrate 7. The measurement means 13 is adapted for acting, without physical contact, with the medium 8 to measure the distance between the liquid jet head 5 and the medium 8. More exactly, the measurement means 13 may be adapted to measure the distance between the liquid system head 9 and the medium 8.

In the example considered herein and as illustrated in FIGS. 3 and 4, the measurement means 13 is constituted by an optical system which comprises, for example, at least one infrared light-emitting diode (LED) 14 which send an incident light beam FI towards the medium 8 so as to form a light spot on the medium 8 together with a reflected light beam FR. The light spot and the reflected light beam FR are sensed by one or a plurality of optical sensors 15 so as to determine the angle of inclination of the incident beam FI relative to the medium and the intensity of the light spot.

Since the distance between the infrared LED 14 and the optical sensor 15 is known per se, and since the angle of inclination of the incident light beam FI and the intensity of the light spot are determined, it is then necessary to merely to use simple trigonometric relationships to determine the distance between the infrared LED 14 and the medium 8, and therefore between the liquid jet system 9 and the medium 8, and therefore between the liquid jet system 9 and the medium 8. The infrared light may also be modulated to reduce possibility of interference with the daylight during the determination of the calculated distance.

The optical sensor 15 is typically formed by a semiconductor diode or phototransistor or photodiode such as infrared photodiode SFH229 sold under the SIEMENS trademark. The infrared emitter may be formed by the IR emitter OPE5794 sold under the OPTEK trademark.

In the embodiment illustrated in FIG. 3, the measurement means 13, which is connected to the control unit 10, includes a plurality of infrared light-emitting diodes 14 and a plurality of optical sensors 15 disposed in the form of ring, each light-emitting diode 14 being disposed between both optical sensors 15, and each optical sensor being disposed between both light-emitting diodes 14, in such a manner that a light-emitting diode 14 and the corresponding optical sensor are preferably diametrically opposed.

In this exemplary embodiment, there are three infrared light-emitting diodes 14 and three optical sensors 15. Of course, the measurement means may include more than three diodes 14 and sensors 15.

In the embodiment as illustrated in FIG. 3, the measurement means 13 is positioned on the second side 72 of the substrate 7 which is made of glass in order to permit to the incident light beams FI and the reflected light beams to come through the substrate 7.

Nevertheless, when the substrate 7 is made of opaque material, the measurement means 13 may be also positioned on the first side 71 of the substrate directly facing the medium 8.

In another embodiment, the measurement means may also have means for emitting a conical light beam or a plurality of conical light beams whose axis of symmetry coincides substantially with the longitudinal axis of the tubular element 2. The measurement means 13 then has an optical sensor or a plurality of optical sensors adapted to determine the radius of the corresponding light spot formed by the corresponding conical beam on the medium 8. Since the radius of the light spot is proportional to the distance between the medium 8 and the emitter means for emitting the conical beams, it is then possible to measure in linear or non-linear manner the distance between said emitter means and the medium 8. Similarly, if the axis of symmetry of the conical beam slopes relative to the medium, the light spot or the plurality of light spots formed on the medium is no longer circular, but rather it is elliptical, and the sensor or the plurality of sensors is also adapted to measure the length of the minor axis of the corresponding elliptical spot in order to measure the corresponding distance between the medium and the emitter members of the emitters means. In this case, and regardless of the inclination of the liquid ejecting instrument 1, the length of the minor axis of each elliptical spot is proportional only to the distance between the medium and each corresponding emitter of the emitter means, and it is only the length of the major axis of each elliptical spot that is proportional to the angle of inclination of the corresponding conical beam.

According to another method, the distance between the liquid system head 9 and the medium may be calculated with the at least one optical sensor by sensing the amplitude of the infrared light reflected from the surface of the medium 8.

In a variant embodiment (not represented), the measure means 13 may also include an ultrasonic acoustic probe or a plurality of ultrasonic acoustic probes directly positioned on the substrate 7.

As can be seen with reference to FIG. 5, the measurement means and more particularly each infrared LED 14 and each optical sensor 15 is coupled directly to the control unit 10 which may store the measurements taken by the measurement means 13. The control unit 10 may also be adapted to cause the measurement means 13 to perform repeated measurements at determined time intervals. Such time intervals could, for example, lie in the range of 1 millisecond (ms) to 0.1 second (s).

In this case, the control unit 10 can thus be used to determine displacements of the liquid jet head 9 relative to the medium 8 as a function of a plurality of distances measured by the measurement means 13 in a plurality of determined time intervals. As described above, the three infrared light-emitting diodes 14 may send three distinct incident light beams FI towards the medium 8 so as to form three light spots on said medium 8 with three reflected light beams FR sensed by the three optical sensors 15. Consequently, when at least one optical sensor 15 detects a variation of the distance in combination with its corresponding and diametrically opposed infrared LED 14, the control unit 10 may interpret that variation as movement of the liquid jet head.

Such relative displacements are detected only when the liquid jet head 9 is not displaced in a plane that is strictly parallel to the planes of the medium. However, when a normal user is using a writing instrument to write, the user automatically transmits tremors to the tubular element 2, such tremors then being automatically detected by the measurements means 13 and by the control unit as being a movement.

Consequently, the control unit may be adapted to cause the liquid jet system 9 to be activated when the measurement means 13 determines that the distance between the medium and the liquid jet system 9 is in an appropriate range or when both the measurement means determines that the distance is in an appropriate range and that the control unit 10 together with the measurement means 13 detect a movement of the liquid jet system 9.

Nevertheless, the substrate 7 may also comprise a movement detector means 16 (FIG. 3) directly positioned on one of the first and second sides 71, 72 of the substrate 7. The movement detector means 16 may also be positioned in another place, for example on the inside wall 21 of the tubular element 2. The movement detector means 16 may be formed, by example, by an accelerometer, a gyroscope, an orientation sensor, a tilt sensor or a vibration detector.

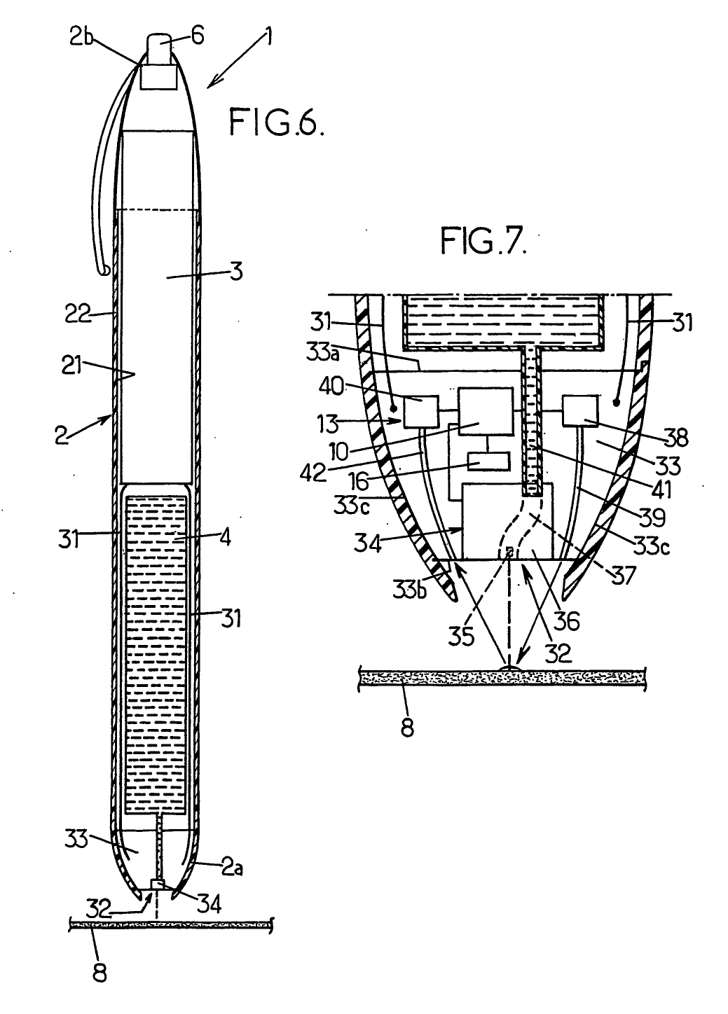

FIGS. 6 and 7 show the liquid ejecting instrument 1 including a liquid jet head 32 according to another embodiment of the present invention. The liquid jet head 32 is also disposed at the open end 2a of the tubular element 2 which may be constituted by an end-piece fitted directly into the inside wall 21 of the central portion of the tubular element 2.

In this second embodiment, the liquid jet head 32 includes a substrate 33 formed by a vertical plate having an upper edge 33a facing the liquid tank 4, a lower edge 33b facing the medium and two lateral edges 33c mounted on the inside wall on the open end 2a of the tubular element. The contour of the lateral edge 33c and the inside wall of the open end 2a of the tubular element 2 have complementary forms and the lateral edges 33c may be fixed on the inside wall by adhesive, welding or by any appropriate means. The substrate 33 also has two parallel sides extending along the longitudinal axis of the tubular element 2.

The liquid jet head 32 further includes a liquid jet system 34 positioned near the lower edge 33b of the substrate 33. The liquid jet system 34 is of a side-shooter style with at least one resistive heater element 35 fixed on one side of the substrate 33 and a block 36 mounted on the same side of the substrate 33, the block 36 having at least one liquid channel 37 extending between an inlet port connected to the supply line 41 of the liquid tank 4 and an outlet port in which is located the resistive heater element 35.

The substrate 33 and the block 36 may be made of materials such as those disclosed for the liquid jet head 5 of the first embodiment.

The liquid jet head 32 also comprises measurement means 13 positioned on the substrate 33. The measurement means, in this embodiment, comprises one infrared light-emitting diode (LED) 38 coupled to light conveying means 39 and one optical sensor 40 coupled to light conveying means 42. More particularly, the light conveying means 39 and 42 may be formed by one or a plurality of optic fibres or molded light pipes to transmit infrared to and from the lower edge 33b of the substrate 33. Consequently, the LED 38 sent an inciding light which is transmitted by the light conveying means 39 towards the medium 8 so as to form one or a plurality of spots on the medium 8. Then the reflected light is sent to the optical sensor 40 via the light conveying means 42 in order to permit the determination of the distance between the medium and the lower edge 33b of the substrate.

The various methods for calculating the distance between the medium and the liquid system head describes in the first embodiment may be applied for this second embodiment. For instance, the optical sensor 40 may be adapted to calculate the distance using the amplitude of the infrared light reflected from the surface of the medium 8.

Each light conveying means 39, 42 may include one or more optic fibres or have a first end coupled with the corresponding LED 38 or corresponding optical sensor 40 and a second end fixed on one side of the substrate 33 or on the inside wall of the open end 2a of the tubular element 2.

The substrate 33 may also include the movement detector means 16 and the control unit 10, as already described in the first embodiment of the present invention.

The liquid jet system 34 may be also formed by a piezoelectric jet head or a MEMS head.

Consequently, according to the aspects of the present invention, the liquid jet head 5; 32 may be constructed as a hand-holdable and preassembled unit comprising at least the substrate 7; 33, the liquid jet system 9; 34 and the measurement means 13, that preassembled unit being directly mounted on the liquid ejecting instrument 1 and connected to electrical power source 3 by means of the power wiring 31.

The control unit 10 may or may not be positioned on the substrate 7; 33 if the liquid ejecting instrument is formed by an ink jet pen with a tubular element or ink jet printer.

Consequently, when the liquid ejecting instrument is formed, for example, by an ink jet pen, the ink jet head 5; 32 forming a preassembled unit permits the user to bring the pen up to an appropriate distance in order to cause the ejection of fine ink droplets onto the medium without requiring any physical contact with the medium 8 or writing surface.

In the same way, when the liquid ejecting instrument is formed by an ink jet printer, the preassembled unit forming the ink jet head; to wit the substrate, the ink jet system and the measurements means; permits to detect the presence of the medium in the region of the ink jet system, thereby avoiding an accidental ejection of ink onto an object other than the medium.

1.-11. (canceled)

12. A liquid jet head comprising:
a substrate adapted to be mounted on a liquid ejecting instrument;
a liquid jet system positioned on the substrate, said liquid jet system being adapted to eject liquid onto a medium from a distance;
a control unit, coupled to said liquid jet system, to activate said liquid jet system for ejecting liquid onto the medium; and
measurement means for acting, without physical contact with the medium, to measure the distance between the liquid jet head and the medium, said measurement means being coupled to said control unit,
wherein said measurement means is positioned on the substrate.

13. A liquid jet head according to claim 1, wherein said control unit is positioned on said substrate.

14. A liquid jet head according to claim 1, wherein said measurement means further comprises an optical system to measure the distance between said liquid jet head and the medium.

15. A liquid jet head according to claim 1, wherein said measurement means further comprises an ultrasonic acoustic probe serving to measure the distance between said liquid jet head and the medium.

16. A liquid jet head according to claim 1, wherein said substrate further comprises a supply channel which extends between an inlet port designed to be connected to a liquid tank housed within the liquid ejecting instrument, and an outlet port connected to said liquid jet system.

17. A liquid jet head according to claim 1, wherein said substrate is made of a material from a group consisting essentially of glass, silicon, ceramic and polymer materials.

18. A liquid jet head according to claim 1, wherein said liquid jet system further comprises a thermal liquid jet system adapted for ejecting liquid droplets from at least one orifice.

19. A liquid jet head according to claim 18, wherein said substrate is formed by a plate having a first side designed to face the medium and a second side opposite to the first side, and wherein said thermal liquid jet system comprises:
at least one resistive heater element positioned on the first side of said substrate, and
a block mounted on the first side of the substrate, said block having at least one liquid channel having an inlet chamber and an outlet orifice facing said at least one resistive heater element for ejecting ink droplets onto the medium.

20. A liquid jet head according to claim 1, further comprising a movement detector means positioned on said substrate, said movement detector means being adapted to detect movement of the liquid jet head, said movement detector means being coupled to said control unit.

21. A liquid ejecting instrument comprising a substantially tubular element extending between a first end and a second end and designed to be hand-held by a user, said tubular element comprising:
a liquid tank;
an electrical power source; and
a liquid jet head according to any one of preceding claims, said liquid jet head being mounted at the first end of the tubular element and connected to the electrical power source.

22. A liquid jet head comprising:
a substrate adapted to be mounted on a liquid ejecting instrument;
a liquid jet system positioned on the substrate, said liquid jet system being adapted to eject liquid onto a medium from a distance;
a control unit coupled to said liquid jet system, to activate said liquid jet system for ejecting liquid onto the medium; and
measurement means for acting, without physical contact with the medium, to measure the distance between the liquid jet head and the medium, said measurement means being coupled to said control unit,
wherein said measurement means is positioned on the substrate; and
a movement detector means positioned on said substrate, said movement detector means being adapted to detect movement of the liquid jet head, said movement detector means being coupled to said control unit.

23. A liquid jet head comprising:
a substrate adapted to be mounted on a liquid ejecting instrument;
a liquid jet system positioned on the substrate, said liquid jet system being adapted to eject liquid onto a medium from a distance;
a control unit, coupled to said liquid jet system, to activate said liquid jet system for ejecting liquid onto the medium; and
measurement means for acting, without physical contact with the medium, to measure the distance between the liquid jet head and the medium, said measurement means being coupled to said control unit,
wherein said measurement means further comprises an optical system to measure the distance between said liquid jet head and the medium.
